(19) United States
(12) Patent Application Publication
(10) Pub. No.: US 2026/0200264 A1
(43) Pub. Date: Jul. 16, 2026

(54) RAILGEAR ASSEMBLY WITH A SINGLE-ACTION ACTIVATION & LOCKING MECHANISM

(71) Applicant: Transportation IP Holdings, LLC, Norwalk, CT (US)

(72) Inventors: Jarred Pollock, Berwick, PA (US); Shane Moran, Berwick, PA (US)

(73) Assignee: Transportation IP Holdings, LLC, Norwalk, CT (US)

(21) Appl. No.: 19/017,205

(22) Filed: Jan. 10, 2025

(51) Int. Cl. B60B 17/00; B60F 1/04

(52) U.S. Cl. CPC B60B 17/0006; B60F 1/043; B60F 2301/04; B60F 2301/10

(57) ABSTRACT

A system including a railgear assembly couplable to a vehicle is disclosed herein. The railgear assembly can transition between a road configuration and a rail configuration. The system can further include a locking assembly that prevents the railgear assembly from transitioning between the road configuration and the rail configuration in a locked position and allows the railgear assembly to transition between the road configuration and the rail configuration in the unlocked position. The system can further include a fluid powered assembly configured to generate a fluid pressure that transitions the locking assembly from the first locked position to the unlocked position when the fluid pressure is less than a determined threshold, and transitions the railgear assembly between the road configuration and the rail configuration when the fluid pressure reaches or exceeds the determined threshold.

### BACKGROUND

### Technical Field

Embodiments of the subject matter disclosed herein relate to railgear assemblies and, specifically, to devices, systems, and methods for unlocking, activating, and locking railgear assemblies.

### Discussion of Art

Railgear assemblies include specialized equipment installed on road vehicles (e.g., trucks, SUVs, maintenance vehicles, etc.) that enables them to operate on both roads and railway tracks. Such dual-mode capability can be beneficial for vehicles used in railway maintenance, inspection, construction, and emergency response. Railgear assemblies can be particularly useful to perform Maintenance-of-Way (MOW) operations, vehicle inspections, emergency response, and/or construction or utility work, amongst other applications. By combining road and rail capabilities, railgear assemblies are an important tool for modern rail industry operations.

For example, a typical railgear assembly includes front and rear railgear units, which are mechanisms configured to be mounted to the front and rear of a vehicle, allowing the vehicle to engage with railway tracks. The rail gear units can include steel wheels configured to align with railway tracks and guide the vehicle along the rails. Railgear assemblies further include hydraulic or pneumatic systems configured to retract the rail wheels when the vehicle is intended to operate on a road or deploy the rail wheels when the vehicle is intended to operate on a railway track. Railgear assemblies can also include control units that include levers, switches, or electronic interfaces that allow the operator to control the hydraulic or pneumatic system and either deploy or retract the rail wheels.

However, existing railgear activation systems introduce complex operations that are time-consuming and high-maintenance. For example, conventional railgear assemblies require multiple steps or actions (e.g., engaging separate levers or switches, manual adjustments, etc.), which take time and increase the risk of operator error, especially under time pressure or in stressful conditions. For example, known railgear assemblies require the railgear unit to be unlocked from an original configuration, activated, and then locked in the new configuration via separate steps, some of which may be manual. Incomplete or improper activation, which may cause derailments, equipment damage, and risk to operating personnel. Moreover, multi-step activation processes can be slow, delaying critical tasks like maintenance or emergency responses, and generally have more mechanical components, which result in more maintenance and downtime. Addressing these issues with streamlined, reliable, and user-friendly activation systems can improve efficiency, safety, and overall operational effectiveness. Accordingly, it may be desirable to provide a railgear assembly that differs from existing assemblies.

### BRIEF DESCRIPTION

In one embodiment, a system including a railgear assembly couplable to a vehicle is provided. The railgear assembly can be configured to transition between a road configuration and a rail configuration. The system can further include a locking assembly configured to transition between a first locked position and an unlocked position. The locking assembly can be configured to prevent the railgear assembly from transitioning between the road configuration and the rail configuration in the first locked position. The locking assembly can be further configured to allow the railgear assembly to transition between the road configuration and the rail configuration in the unlocked position. The system can further include a fluid powered assembly configured to be fluidically coupled to the locking assembly and the railgear assembly. The fluid powered assembly can be configured to generate a fluid pressure in response to a user input. When the fluid pressure is less than a determined threshold the fluid powered assembly is configured to transition the locking assembly from the first locked position to the unlocked position. When the fluid pressure reaches or exceeds the determined threshold, the fluid powered assembly is configured to transition the railgear assembly between the road configuration and the rail configuration.

In another embodiment, a method of unlocking and activating a railgear assembly is provided. The method can include providing fluid to a manifold in response to a user input, generating a pressure with the fluid within the manifold, and transitioning, by the pressure, a locking assembly from a first locked position to an unlocked position when the pressure is less than a determined threshold. The locking assembly can be configured to prevent a railgear assembly from transitioning between a road configuration and a rail configuration in the first locked position. The locking assembly can be further configured to allow the railgear assembly to transition between the road configuration and the rail configuration in the unlocked position. The method can further include transitioning, by the pressure, the railgear assembly between the road configuration and the rail configuration when the pressure is greater than or equal to the determined threshold, and transitioning the locking assembly of a railgear from the unlocked position to a second locked position in response to the railgear assembly having transitioned between the road configuration and the rail configuration.

According to yet another embodiment, a fluid powered assembly fluidically couplable to a railgear assembly is provided. The fluid powered assembly can include a fluid powered actuator configured to transition a railgear assembly between a road configuration and a rail configuration. The fluid powered assembly can further include a locking assembly configured to transition between a first locked position and an unlocked position The locking assembly can be configured to prevent the railgear assembly from transitioning between the road configuration and the rail configuration in the first locked position. The locking assembly can be further configured to allow the railgear assembly to transition between the road configuration and the rail configuration in the unlocked position. The fluid powered assembly can further include a manifold configured to receive fluid from a pump in response to a user input. The fluid can be configured to generate a pressure within the manifold. The manifold can include a valve configured to transition from an open position to a closed position when the pressure meets or exceeds a determined threshold. The manifold can be further configured to provide the fluid to the locking assembly when the valve is in the open position, causing the locking assembly to transition from the first locked position to the unlocked position. The manifold can be further configured to provide the fluid to the fluid powered actuator when the valve is in the closed position, causing the fluid powered actuator to transition the railgear assembly between the road configuration and the rail configuration.

### BRIEF DESCRIPTION OF THE DRAWINGS

The subject matter described herein may be understood from reading the following description of non-limiting embodiments, with reference to the attached drawings, wherein below:

FIG. 1 illustrates a side view of a vehicle including a railgear assembly with a single-action activation and locking mechanism according to one embodiment.

FIG. 2 illustrates a perspective view of a railgear unit of the railgear assembly of FIG. 1 according to one embodiment of the present disclosure.

FIG. 3 illustrates a perspective view of a locking assembly of the railgear unit of FIG. 2 according to one embodiment of the present disclosure.

FIG. 4 illustrates a perspective view of a cam assembly of the locking assembly of FIG. 3 according to one embodiment of the present disclosure.

FIG. 5 illustrates an elevation view of a fluid powered assembly of the railgear assembly of FIG. 1 according to one embodiment of the present disclosure.

FIG.s 6A-D illustrate perspective views of the railgear assembly of FIG. 1 in various stages of a single-action fluid powered lock and activation.

FIG. 7A and 7B illustrate perspective views of the vehicle FIG. 1 with the railgear assembly in a road configuration and a rail configuration, respectively.

FIG. 8 illustrates a flow chart of a method of activating and locking a railgear assembly with a single action.

### DETAILED DESCRIPTION

Various aspects of the disclosure relate to railgear assemblies specifically configured for a single-action fluid powered lock and activation. Such railgear assemblies may allow a vehicle to transition between road and rail configuration in a single action, saving time compared to conventional, multi-step processes for deployment. This can be beneficial in time-sensitive operations, including railway maintenance or emergency response. Additionally, simplifying the activation process can reduce the complexity of operating the railgear, making it more user-friendly and reducing the likelihood of operator error. A quicker and simpler activation process can also minimize risks during transitions, especially in situations where the vehicle is exposed to hazards (e.g., crossing active roads or rail lines or operating in confined spaces). Consolidating the activation mechanism can further reduce mechanical wear and tear caused by multiple moving parts or repeated operations, improving long-term reliability. Moreover, with a simpler activation system, operators may require less training, saving time and resources for organizations. Fewer components can further result in a lighter and potentially more durable system.

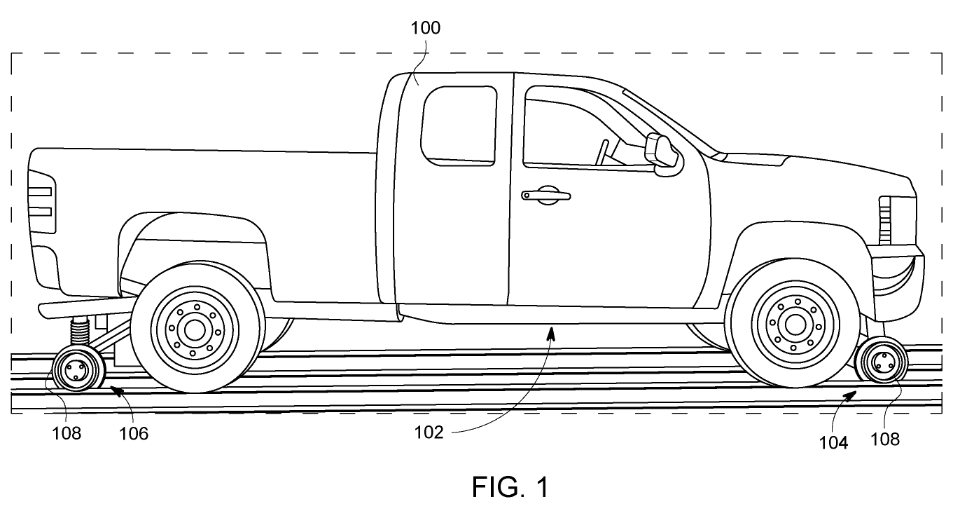

Referring now to FIG. 1, a side view of a vehicle 100 with a railgear assembly 102 configured for single-action fluid powered lock and activation is depicted according to one embodiment of the present disclosure. According to the non-limiting embodiment of FIG. 1, the vehicle is class two vehicle, such as a pickup truck. As such, the railgear assembly can include a first railgear unit 104 mounted to the front of the vehicle and a second railgear unit 106 mounted to the rear of the vehicle. However, according to other embodiments, the vehicle can be a different type of vehicle (e.g., vans, construction vehicles, bucket trucks, large walk-in, utility trucks, tractor trailers, etc.) classified in various classes (e.g., class one, class three, class four, class five, class six, class seven, class eight, etc.). According to such embodiments, the railgear assembly can include additional one or more additional railgear units mounted in other positions along the length of the vehicle.

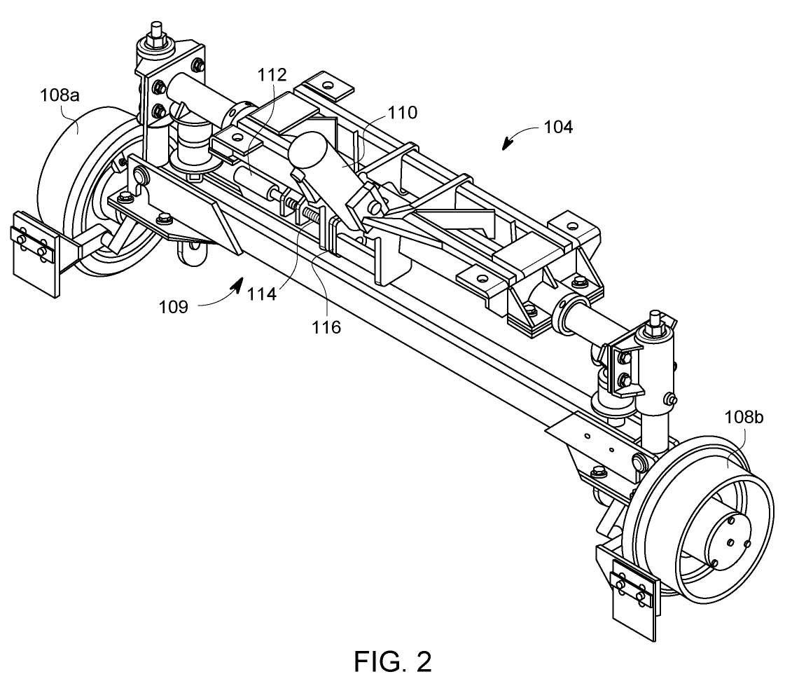

Each of the railgear units of the railgear assembly of FIG. 1 is configured to transition between a road configuration and a rail configuration via an actuator, as will be described in further detail with reference to FIG. 2. The actuators can be fluid powered, including either pneumatic or hydraulic power, and can be fluidically coupled via a manifold configured to convey a fluid (e.g., gaseous fluids, liquid fluids, etc.), which can be provided from an external source. As will be described in further detail herein, the actuators transition the railgear units between a road configuration, wherein rail wheels 108 of the railgear unit are raised, and a rail configuration, wherein rail wheels of the railgear unit are lowered. In this way, the vehicle, which is generally configured to traverse on a road, can be selectively configured to traverse on rail tracks. As depicted in FIG. 1 the first and second railgear units are in the rail configuration, as the rail wheels of the railgear unit are lowered such that they are contacting rail tracks.

Referring now to FIG. 2, a railgear unit of the railgear assembly of FIG. 1 is depicted according to one embodiment of the present disclosure. According to the embodiment of FIG. 2, the first railgear unit is specifically shown. However, the second railgear unit of the railgear assembly of FIG. 1 can be similarly configured and operated, as will be described in reference to the first railgear unit of FIG. 2. As depicted in FIG. 2, the railgear unit can include a right rail wheel 108a and a left rail wheel 108b, which are respectively configured and spaced apart to engage a right and left rail of a railway track when the railgear unit is in the rail configuration. The right and left rail wheels can be geometrically and dimensionally configured to engage railway tracks of any configuration.

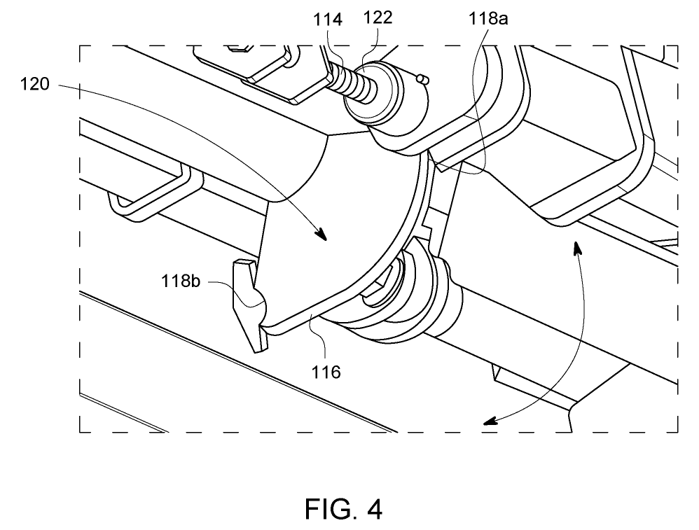

According to the embodiment of FIG. 2, the railgear unit can further include a locking assembly 109 that can include a fluid powered cylinder 112, a pin lock 114, and a cam assembly 116. For example, the fluid powered cylinder can be a hydraulic cylinder fluidically coupled to a hydraulic assembly and, therefore, configured to receive fluid that generates a fluidic pressure from a hydraulic assembly. For example, according to the embodiment of FIG. 2, the cylinder is a hydraulic cylinder. However, according to other embodiments, the cylinder can be a pneumatic cylinder configured to receive fluid that generates a fluidic pressure from a pneumatic assembly. The hydraulic cylinder can be further configured to accommodate at least a portion of the pin lock, which can transition between a distal position and a proximal position relative to the hydraulic cylinder in response to the fluidic pressure provided by the hydraulic or pneumatic assembly. As will be described in further detail with reference to FIG. 4, the cam assembly can include at least two geometric features ( e.g. , cams, apertures, etc.), one of which corresponds to the road configuration of the railgear assembly the other of which corresponds to the rail configuration of the railgear assembly. The railgear unit is arranged such that, when the pin lock is in the distal position, one of the geometric features accommodate the pin lock, which provides a mechanical interference that prevents the cam assembly—and therefore, the railgear unit—from rotating. In other words, when the pin lock is in the distal position, the railgear unit is in a locked position, either in the road configuration or the rail configuration depending on which geometric feature of the cam assembly is accommodating the pin lock.

However, when fluidic pressure is provided by the hydraulic or pneumatic assembly, the hydraulic cylinder causes the pin lock to transition from the distal position to the proximal position, wherein neither of the geometric features of the cam assembly accommodates the pin lock. In the proximal position, the pin lock does not mechanically interfere with the cam assembly such that the cam assembly—and therefore, the railgear unit—can freely rotate between the road configuration and the rail configuration. Thus, the locking assembly can be configured to enable the railgear unit to transition between a first locked position (e.g., the road configuration), an unlocked position (e.g., where the railgear unit can freely move between the road configuration and the rail configuration), and a second locked position (e.g., the rail configuration). Of course, according to other embodiments, the cam assembly can include one or more additional geometric features ( e.g. , cams, apertures, etc.) such that the railgear unit can be locked in additional configurations intermediate and/or beyond the road configuration and rail configuration.

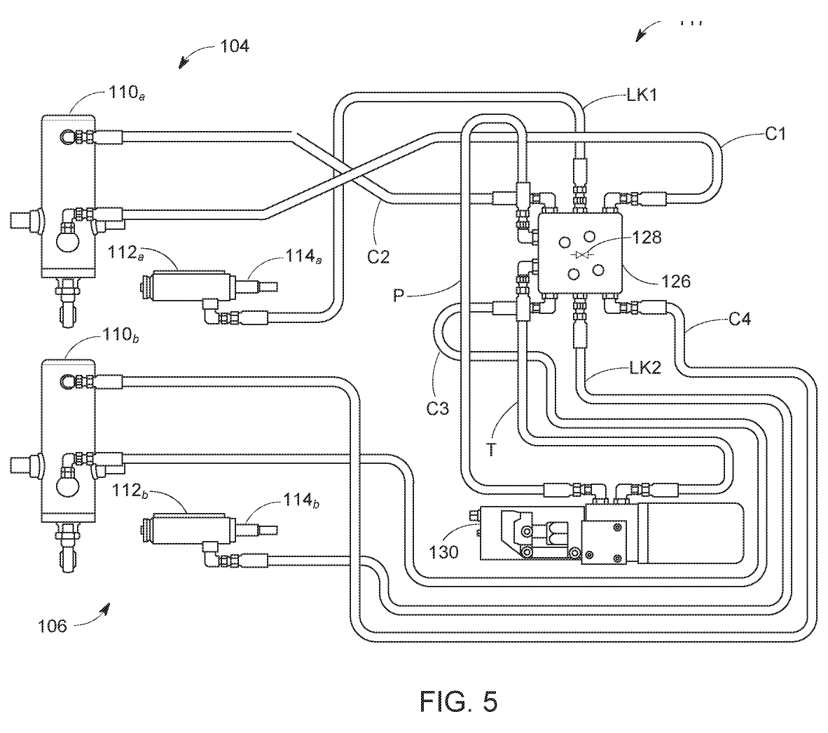

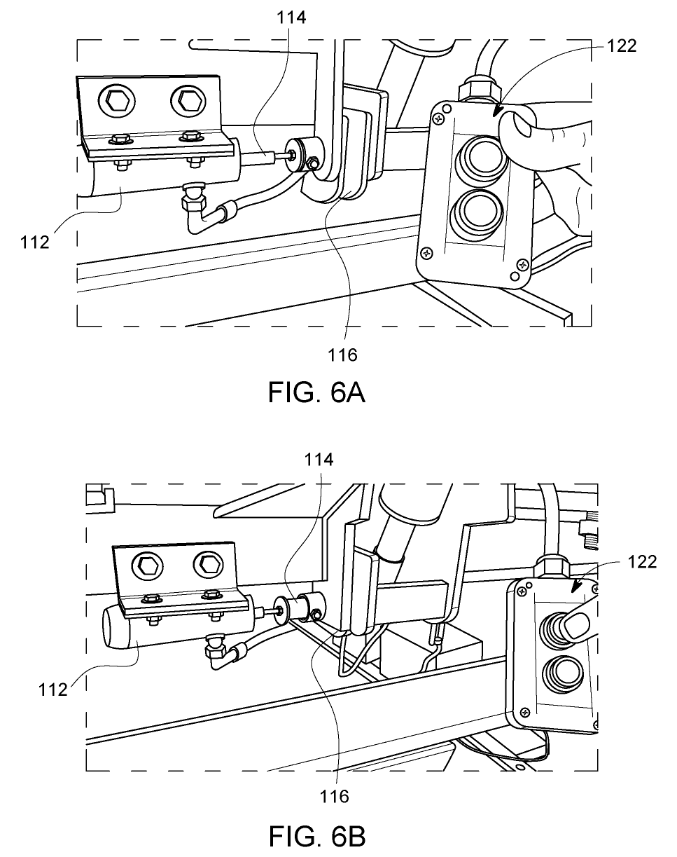

In further reference to FIG. 2, the railgear unit can further include a hydraulic actuator 110, which is fluidically coupled to and part of the broader hydraulic assembly, as will be described in further detail with reference to FIG. 5. The actuator can be mechanically coupled to the cam assembly and configured to cause the cam assembly—and therefore, the railgear assembly—to rotate between the road configuration and the rail configuration in response to fluidic pressure provided by the hydraulic assembly. However, according to other embodiments, the actuator can be a pneumatic cylinder fluidically coupled to and part of a broader pneumatic assembly. As will be discussed in further detail with reference to FIG. 5, in response to a single user input, the hydraulic assembly can first provide fluid that generates a fluidic pressure to the hydraulic cylinder when the fluidic pressure is less than a determined threshold. In response to the fluidic pressure, the hydraulic cylinder can transition the pin lock from the distal or locked position to the proximal or unlocked position, allowing the cam assembly to rotate freely between the road and rail configurations. However, when the fluidic pressure reaches or exceeds the determined threshold, the hydraulic assembly can seamlessly reroute the fluid from the hydraulic cylinder to the actuator without requiring an additional user input. In response to the fluidic pressure, the actuator can cause the cam assembly—and therefore, the railgear assembly—to rotate between the road configuration and the rail configuration.

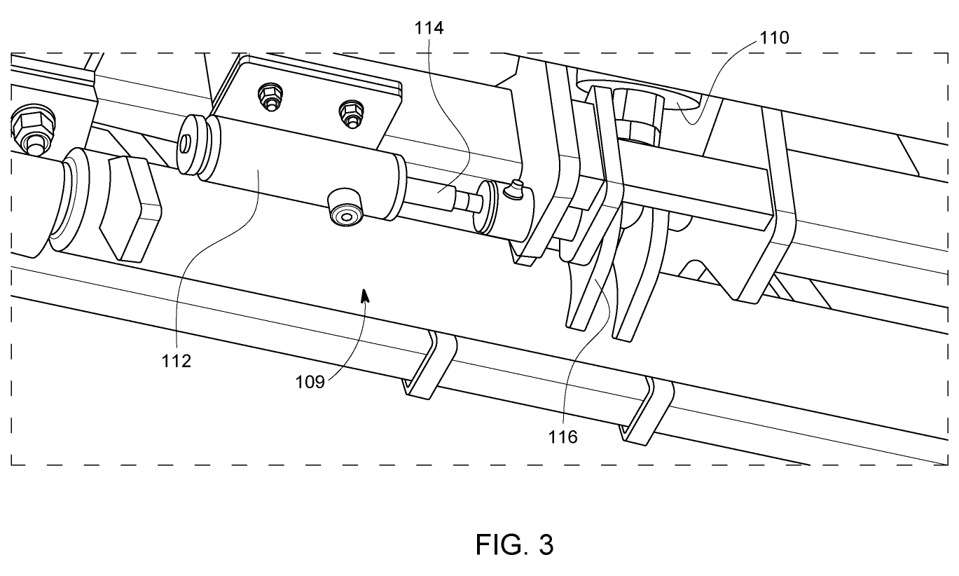

Referring now to FIG. 3, a perspective view of the locking assembly of the railgear unit of FIG. 2 is depicted according to one embodiment of the present disclosure. Specifically, one specific arrangement of the hydraulic cylinder, pin lock, and cam assembly of the locking assembly is depicted with the actuator mechanically coupled to the cam assembly depicted in the background. According to FIG. 3, the pin lock is in the distal or locked position and, therefore, is creating mechanical interference preventing the cam assembly—and therefore, the railgear unit—from transitioning from the road configuration to the rail configuration. FIG. 4 illustrates a perspective view of a cam assembly of the locking assembly of FIG. 3 in more detail. Specifically, the first geometric feature 118a and the second geometric feature 118b of the cam assembly, each of which corresponds to the road configuration and the rail configuration are depicted. According to FIG. 4, the first and second geometric features can include chamfers defined into the sides of the cam assembly. However, as previously discussed, the present disclosure contemplates other geometric features configured to accommodate the pin lock.

According to FIG. 4, the locking assembly can further include a spring 123 positioned about the pin lock. The spring can include a spring constant specifically configured to bias the pinlock in the distal or locked position, as depicted in FIG. 4, when no fluidic pressure is provided to the hydraulic cylinder by the hydraulic assembly. However, when the hydraulic assembly provides a fluid, which generates a fluidic pressure within the hydraulic cylinder, the fluidic pressure can apply a force on the pin lock sufficient to overcome a biasing force provided by the spring constant. Thus, in response to the fluidic pressure provided to the hydraulic cylinder by the hydraulic assembly, the spring force can be overcome and the pin lock can transition to the distal or unlocked position, allowing the cam assembly—and therefore, the railgear unit—to freely rotate between the road configuration and the rail configuration.

As further depicted in FIG. 4, the cam assembly can define a flat, solid surface 120 between the geometric features. Thus, even after fluidic pressure is provided to the hydraulic cylinder and rerouted to the actuator, the flat, solid surface can mechanically interfere with the pin lock even, preventing the pin lock from returning to the distal position even when the spring bias is no longer overcome by the fluidic pressure. In other words, the pin lock has nowhere to go until the cam assembly—and therefore, the railgear unit—arrives in the rail configuration, after which the second geometric feature can accommodate the pin lock. This alleviates the spring force and the spring biases the pin lock into the second geometric feature. In this configuration, the cam assembly is in a second locked position, such that the railgear unit is locked in the rail configuration. According to other embodiments, the spring can be alternately positioned, for example, within the hydraulic cylinder or intermediate at least a portion of the pin lock and a fixed, immovable surface.

Referring now to FIG. 5, an elevation view of a hydraulic assembly 117 of the railgear assembly of FIG. 1 is depicted according to one embodiment of the present disclosure. For example, according to the embodiment of FIG. 4, the assembly can include a hydraulic assembly configured to convey a fluid (e.g.,a hydraulic fluid) to components of the railgear assembly, such as the actuator and the hydraulic cylinder. As previously described, the fluid can generate pressure within each component to enable the aforementioned functionality. However, according to other embodiments, the assembly can be configured to convey other fluids to the components of the railgear assembly. For example, according to other embodiments, the assembly can include any fluid powered assembly, including a pneumatic assembly configured to convey a gaseous fluid (e.g., air) to the components of the railgear assembly. According to such embodiments, the railgear components can be pneumatic components configured to perform the aforementioned functionality in response to pressure generated by the gas.

According to the non-limiting aspect of FIG. 5, the hydraulic assembly can include a first hydraulic actuator 110a configured to transition the front railgear unit between the road configuration and the rail configuration. The hydraulic assembly can further include a second hydraulic actuator 110b configured to transition the rear railgear unit between the road configuration and the rail configuration. Likewise, a first locking assembly can include a first hydraulic cylinder 112a and first pin lock 114a configured to lock the front railgear unit in the road configuration and rail configuration and a second locking assembly can include a second hydraulic cylinder 112b and second pin lock 114b configured to lock the rear railgear unit in the road configuration and rail configuration. The hydraulic assembly can further include a manifold 126 configured to fluidically couple the actuators and hydraulic cylinders and provide the actuators and hydraulic cylinders with a hydraulic fluid from a source 130, for example, a pump and/or reservoir.

For example, according to FIG. 5, the hydraulic assembly can include a first line LK1 configured to hydraulically couple the manifold to the first hydraulic cylinder of the locking assembly of the front railgear unit and a second line LK2 configured to hydraulically couple the manifold to the second hydraulic cylinder of the locking assembly of the rear railgear unit. A third line C1 and fourth line C2 can be configured to hydraulically couple the manifold to the first actuator of the front railgear unit. Likewise, a fifth line C3 and sixth line C4 can be configured to hydraulically couple the manifold to the first actuator of the front railgear unit. A seventh line P and eighth line T can be configured to hydraulically couple the manifold to an external source of hydraulic fluid, such as a pump.

The manifold of the hydraulic assembly of FIG. 5 can be configured to selectively provide the actuators and hydraulic cylinders with hydraulic fluid such that the railgear units of the railgear assembly can be unlocked and actuated in response to the hydraulic assembly receiving a single user input. The manifold can be specifically configured to provide the fluid to the hydraulic cylinder when a fluidic pressure generated by the fluid within the manifold is less than a determined threshold. When the fluidic pressure within the manifold reaches or exceeds the determined threshold, the manifold can autonomously reroute the fluid from the hydraulic cylinder to the actuator without requiring an additional user input. According to some embodiments, the manifold can accomplish this via one or more pressure-sensitive valves 128 (e.g., a check valve, a non-return valve, a tilting disk valve, a pilot valve, a diaphragm valve, a direct-acting valve, a relief valve, etc.). For example, according to one embodiment, a pressure-sensitive valve can be implemented within the manifold for each of the hydraulic cylinders and actuators and specifically configured to open and close in response to determined pressures.

For example, a check valve may be configured such that, upon the initial provision of fluid in response to a single user input, the pressure within the manifold is relatively low and thus, exists below a determined threshold specifically configured to activate the pressure-sensitive valves fluidically coupled to the hydraulic cylinders. Thus, when the pressure is below the determined threshold, the pressure-sensitive valves remain open and the manifold to provide the fluid to the hydraulic cylinder, which can generate a fluidic pressure within the hydraulic cylinder that causes the hydraulic cylinder to transition the pin lock from the distal or locked position to the proximal or unlocked position. In the unlocked position, the pin lock can allow the cam assembly to rotate freely between the road and rail configurations. The pressure-sensitive valves fluidically coupled to each of the actuators can be specifically configured to remain closed when the pressure within the manifold is below the determined threshold. Accordingly, the manifold does not provide the fluid to the actuators.

However, when the fluidic pressure reaches or exceeds the determined threshold, the pressure-sensitive valves fluidically coupled to the hydraulic cylinders can be configured to close and the pressure-sensitive valves fluidically coupled to the actuators can be configured to open, which can cause the manifold to reroute the fluid from the hydraulic cylinder to the actuator. The fluid can generate a fluidic pressure within the actuator, which can cause the actuator to transition the cam assembly—and therefore, the railgear assembly—to rotate between the road configuration and the rail configuration. Therefore, a single user input can cause the manifold to receive fluid from the external source. However, after the single user input is provided, the pressure that is naturally generated within the manifold can cause the hydraulic assembly to autonomously and sequentially unlock and activate the railgear units without requiring additional user input. Additionally, the railgear units can be autonomously locked after activation due to the geometric features of the cam assemblies and springs of the locking assemblies, which bias the pin locks in the distal position. The hydraulic assembly, therefore, can enable the railgear assembly to be autonomously unlocked, activated, and locked in response to a single user input.

Referring now to FIGS. 6A-D, several perspective views of the railgear assembly of FIG. 1 are depicted in various stages of a single-action hydraulic lock and activation according to one embodiment. According to FIG. 6A, a user has not provided a singular user input via a controller 122. Although the controller of FIGS. 6A-D includes a push-button configured to receive the user input, according to other embodiments, the controller can include a hydraulic lever configured to receive the user input. In FIG. 6A, the railgear unit is locked in the rail configuration, with the pin lock in the distal position relative to the hydraulic cylinder. However, according to FIG. 6B, the user has applied the singular user input via the controller. The manifold of the hydraulic assembly has begun providing fluid and, because the initial fluidic pressure is below the determined threshold, fluid is only being routed to the hydraulic cylinder. In response to the pressure generated by the fluid, the hydraulic cylinder has caused the pin lock to transition from its distal, locked position to its proximal, unlocked position. According to FIG. 6C, the fluidic pressure within the manifold has reached or exceeded the determined threshold and, therefore, the manifold has routed fluid to the actuator, which is transitioning the railgear configuration from the road configuration to the rail configuration. The pin lock is prevented from returning to the distal position relative to the hydraulic cylinder by the surface of the cam assembly. Finally, FIG. 6D depicts the railgear unit locked in the road configuration, with the pin lock in the distal position relative to the hydraulic cylinder. Specifically, the aperture of the cam assembly enabled the pin lock to return to the distal position relative to the hydraulic assembly in response to the biasing spring force.

According to some non-limiting aspects, the controller of FIGS. 6A-D can be positioned within a cab of the vehicle. For example, the controller can be mounted to or integrated within a dashboard of the vehicle. According to other non-limiting aspects, the controller can be digitally implemented and accessed via one or more computing devices (e.g., an automotive head unit, an infotainment system, a wearable, a smartphone, a tablet, a laptop, a desktop computer, a server, etc.) either positioned within the cab or remotely positioned relative to the vehicle. For example, one or more features of the controller depicted in FIGS. 6A-D can be incorporated into a user interface presented via a display communicatively coupled to the one or more computing devices.

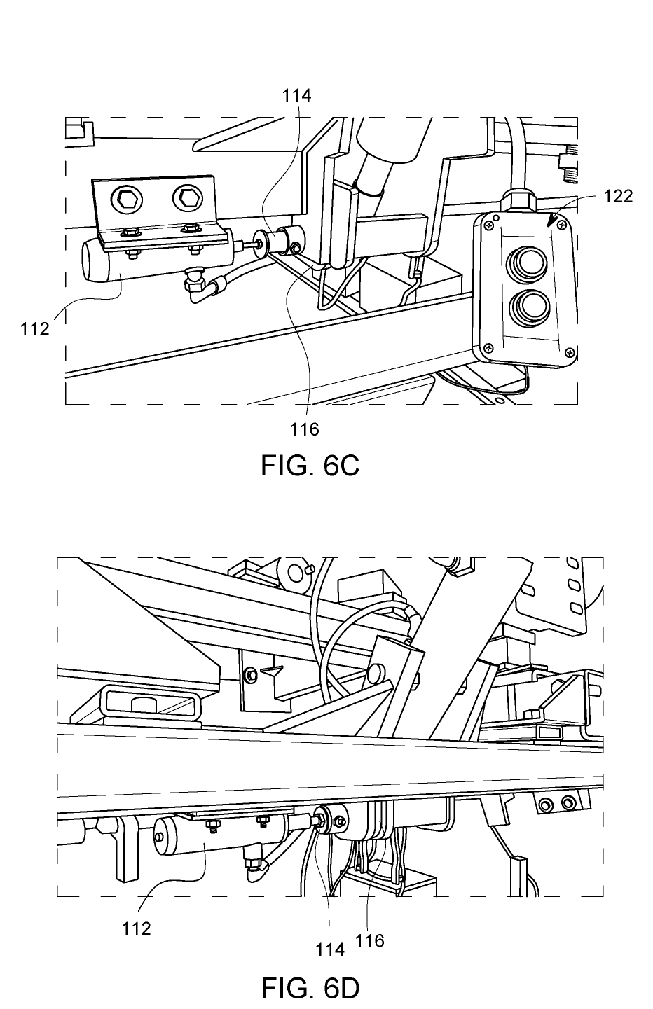

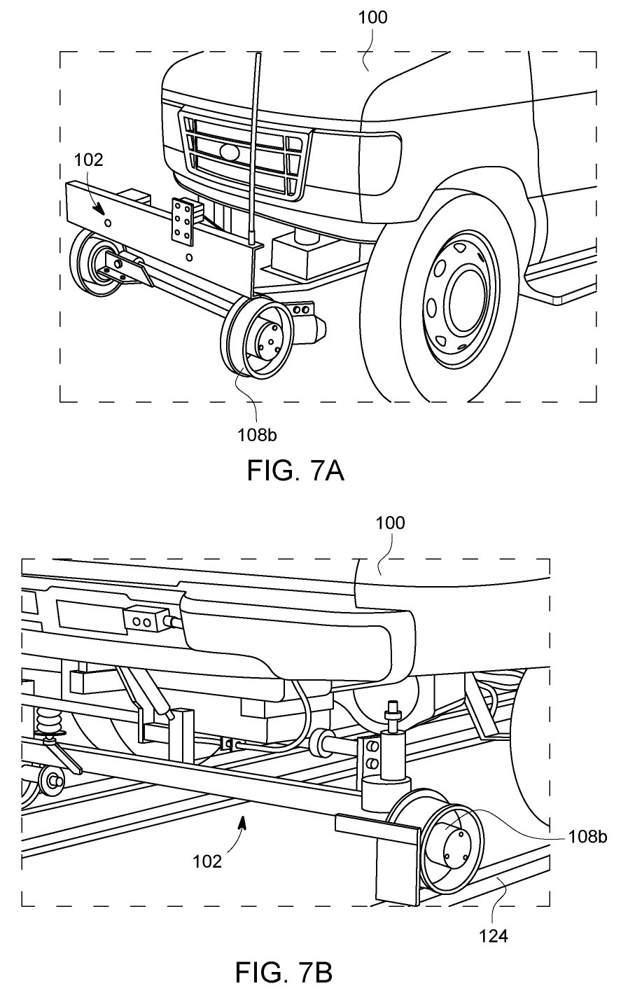

Referring now to FIG. 7A and 7B, perspective views of the vehicle FIG. 1 with the railgear assembly in a road configuration and a rail configuration, respectively. For example, FIG. 7A illustrates the front railgear unit of the railgear assembly locked in the road configuration, wherein the rail wheels are elevated above a surface on which the wheels of the vehicle is traversing. However, according to FIG. 7B, the front railgear unit has been unlocked and transitioned into the rail configuration, wherein the rail wheels have been lowered such that they mechanically engage a pair of rail tracks 124. According to one aspect, the rear railgear unit can be similarly transitioned between a road and rail configuration, as depicted in FIG. 7A and 7B. According to some embodiments, the manifold of the hydraulic assembly of FIG. 5 can be configured such that the front railgear unit and rear railgear can be transitioned between the road and rail configurations either independently of or simultaneously.

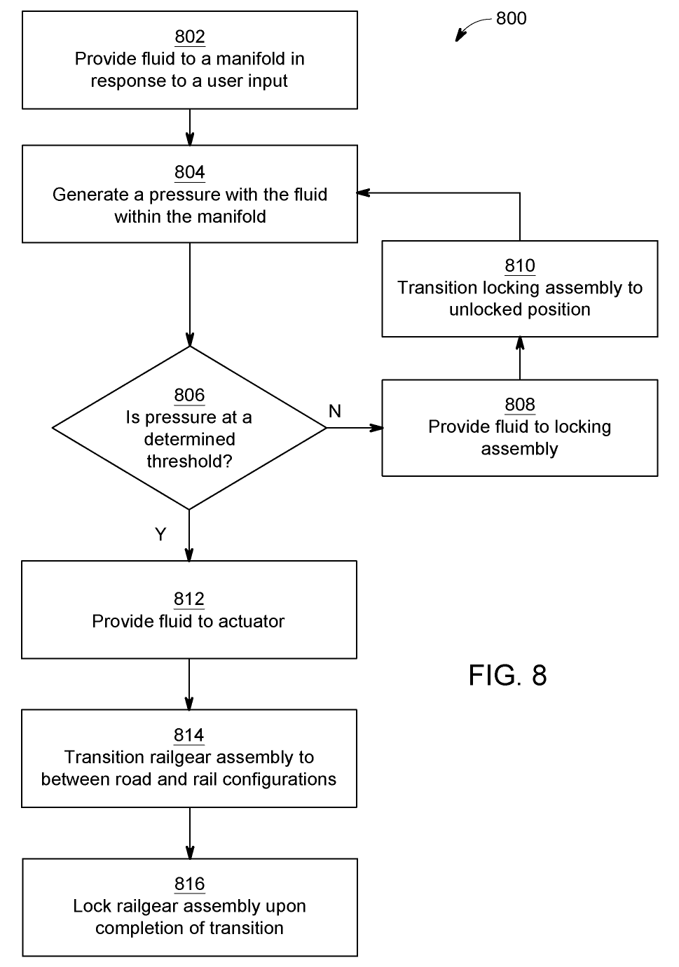

FIG. 8 illustrates a flow chart of a method 800 of activating and locking a railgear assembly with a single user or operator action. According to FIG. 8, the method can include providing 802 a fluid to a manifold of a hydraulic assembly of a railgear assembly in response to a single user input and generating 804 a fluid pressure within the manifold in response to the fluid. The method can further include determining 806 if the fluidic pressure is at a determined threshold. If the pressure has not reached the determined threshold, the method can include providing 808 the fluid to a locking assembly of the railgear assembly and transitioning 810 the locking assembly from a locked position to an unlocked position, and continuing to generate pressure within the manifold in response to the fluid. According to some embodiments, transitioning the locking assembly from the locked position to the unlocked position can include transitioning a pin lock from a distal position relative to a hydraulic cylinder to a proximal position relative to the hydraulic cylinder. Transitioning the pin lock from the distal position to the proximal position can further include removing from the pin lock from a cam assembly of the railgear assembly.

However, if the pressure has reached or exceeded the determined threshold, the method can further include providing 812 the fluid to an actuator of the hydraulic assembly and transitioning 814 the railgear assembly between a road and rail configuration in response to pressure generated by the fluid within the actuator. According to some embodiments, transitioning the railgear assembly between the road configuration and the rail configuration can include transitioning a valve of the manifold from an open position when the pressure is less than the determined threshold to a closed position when the pressure is greater than or equal to the determined threshold. when the pressure is less than the determined threshold. Once the railgear assembly has completed its transition, the method can further include locking 816 the railgear assembly. For example, locking the railgear assembly can include draining the fluid from the hydraulic cylinder and actuator, disabling both. Assuming the locking pin is properly aligned, no mechanical interference can prevent the locking pin from transitioning to its distal position relative to the hydraulic cylinder such that it sits within the aperture of the cam assembly in a locked configuration.

Examples of the devices, systems, and methods disclosed herein, according to various aspects of the present disclosure, are provided below in the following embodiments. An aspect of the methods may include any one or more than one of, and any combination of, the embodiments described below.

In a first embodiment, the present disclosure provides a system including a railgear assembly couplable to a vehicle. The railgear assembly can be configured to transition between a road configuration and a rail configuration. The system can further include a locking assembly configured to transition between a first locked position and an unlocked position. The locking assembly can be configured to prevent the railgear assembly from transitioning between the road configuration and the rail configuration in the first locked position. The locking assembly can be further configured to allow the railgear assembly to transition between the road configuration and the rail configuration in the unlocked position. The system can further include a fluid powered assembly configured to be fluidically coupled to the locking assembly and the railgear assembly. The fluid powered assembly can be configured to generate a fluid pressure in response to a user input. When the fluid pressure is less than a determined threshold the fluid powered assembly is configured to transition the locking assembly from the first locked position to the unlocked position. When the fluid pressure reaches or exceeds the determined threshold, the fluid powered assembly is configured to transition the railgear assembly between the road configuration and the rail configuration.

Additionally, in the first embodiment, the fluid powered assembly can include a valve configured to transition between an open position and a closed position. The valve can remain in the open position when the pressure is less than the determined threshold. The valve can transition from the open position to the closed position when the pressure is greater than or equal to the determined threshold.

Additionally, in the first embodiment, the locking assembly can include a pin lock configured to transition between the first locked position and the unlocked position. The pin lock can be configured to prevent the railgear assembly from transitioning between the road configuration and the rail configuration in the first locked position. The pin lock can be further configured to allow the railgear assembly to transition between the road configuration and the rail configuration in the unlocked position.

Additionally, in the first embodiment, the locking assembly can include a fluid powered cylinder configured to house a portion of the pin lock. The pin lock can be configured to transition between a proximal position and a distal position relative to the fluid powered cylinder. The fluid powered cylinder can be configured to cause the pin lock to transition from the distal position to the proximal position in response to the pressure provided by the fluid powered assembly.

Additionally, in the first embodiment, the railgear assembly can include a cam assembly configured to accommodate the pin lock in the first locked position. The cam assembly does not accommodate the pin lock in the unlocked position.

Additionally, in the first embodiment, the locking assembly can include a spring configured to bias the pin lock in the distal position.

Additionally, in the first embodiment, the locking assembly can be further configured to transition between the first locked position, the unlocked position, and a second locked position.

Additionally, in the first embodiment, the locking assembly can be configured to prevent the railgear assembly from transitioning out of the road configuration in the first locked position. The locking assembly can be further configured to prevent the railgear assembly from transitioning out of the rail configuration in the second locked position.

Additionally, in the first embodiment, the railgear assembly can include a fluid powered actuator configured to cause the railgear assembly to transition between the road configuration and the rail configuration in response to the pressure provided by the fluid powered assembly.

Additionally, in the first embodiment, the fluid powered assembly can include a fluid powered lever, and wherein the user input is mechanically provided via the fluid powered lever.

Additionally, in the first embodiment, the user input can be electrically provided via a computing device configured to communicate with the fluid powered assembly.

In a second embodiment, the present disclosure provides a method. The method can include providing fluid to a manifold in response to a user input, generating a pressure with the fluid within the manifold, and transitioning, by the pressure, a locking assembly from a first locked position to an unlocked position when the pressure is less than a determined threshold. The locking assembly can be configured to prevent a railgear assembly from transitioning between a road configuration and a rail configuration in the first locked position. The locking assembly can be further configured to allow the railgear assembly to transition between the road configuration and the rail configuration in the unlocked position. The method can further include transitioning, by the pressure, the railgear assembly between the road configuration and the rail configuration when the pressure is greater than or equal to the determined threshold, and transitioning the locking assembly of a railgear from the unlocked position to a second locked position in response to the railgear assembly having transitioned between the road configuration and the rail configuration.

Additionally, in the second embodiment, transitioning the railgear assembly between the road configuration and the rail configuration can include transitioning a valve of the manifold from an open position when the pressure is less than the determined threshold to a closed position when the pressure is greater than or equal to the determined threshold.

Additionally, in the second embodiment, transitioning the locking assembly from the first locked position to the unlocked position can include transitioning a pin lock from a distal position relative to a fluid powered cylinder to a proximal position relative to the fluid powered cylinder when the pressure is less than the determined threshold.

Additionally, in the second embodiment, transitioning the pin lock from the distal position to the proximal position can include removing from the pin lock from a cam assembly of the railgear assembly.

In a third embodiment, the present disclosure provides a fluid powered assembly. The fluid powered assembly can include a fluid powered actuator configured to transition a railgear assembly between a road configuration and a rail configuration. The fluid powered assembly can further include a locking assembly configured to transition between a first locked position and an unlocked position The locking assembly can be configured to prevent the railgear assembly from transitioning between the road configuration and the rail configuration in the first locked position. The locking assembly can be further configured to allow the railgear assembly to transition between the road configuration and the rail configuration in the unlocked position. The fluid powered assembly can further include a manifold configured to receive fluid from a pump in response to a user input. The fluid can be configured to generate a pressure within the manifold. The manifold can include a valve configured to transition from an open position to a closed position when the pressure meets or exceeds a determined threshold. The manifold can be further configured to provide the fluid to the locking assembly when the valve is in the open position, causing the locking assembly to transition from the first locked position to the unlocked position. The manifold can be further configured to provide the fluid to the fluid powered actuator when the valve is in the closed position, causing the fluid powered actuator to transition the railgear assembly between the road configuration and the rail configuration.

Additionally, in the third embodiment, the locking assembly can include a pin lock configured to transition between the first locked position and the unlocked position. The pin lock can be configured to prevent the railgear assembly from transitioning between the road configuration and the rail configuration in the first locked position. The pin lock can be further configured to allow the railgear assembly to transition between the road configuration and the rail configuration in the unlocked position.

Additionally, in the third embodiment, the locking assembly can include a fluid powered cylinder configured to house a portion of pin lock. The pin lock can be configured to transition between a proximal position and a distal position relative to the fluid powered cylinder. The fluid powered cylinder can be further configured to cause the pin lock to transition from the distal position to the proximal position in response to the pressure provided by the manifold.

Additionally, in the third embodiment, the railgear assembly can include a cam assembly configured to accommodate the pin lock in the first locked position and not configured to accommodate the pin lock in the unlocked position.

Additionally, in the third embodiment, the fluid powered assembly can further include a fluid powered actuator. The valve can be configured to provide the fluid to the fluid powered actuator when the pressure is greater than or equal to the determined threshold, causing the railgear assembly to transition between the road configuration and the rail configuration.

One or more components may be described as "configured to," "configurable to," "operable/operative to," "adapted/adaptable to," or similar terms. Unless explicitly stated, these terms encompass components in both active and inactive states. Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A system, comprising:
a railgear assembly couplable to a vehicle, wherein the railgear assembly is configured to transition between a road configuration and a rail configuration;
a locking assembly configured to transition between a first locked position and an unlocked position, wherein the locking assembly is configured to prevent the railgear assembly from transitioning between the road configuration and the rail configuration in the first locked position, and wherein the locking assembly is configured to allow the railgear assembly to transition between the road configuration and the rail configuration in the unlocked position; and
a fluid powered assembly configured to be fluidically coupled to the locking assembly and the railgear assembly, wherein the fluid powered assembly is configured to generate a fluid pressure in response to a user input that:
is configured to transition the locking assembly from the first locked position to the unlocked position based on the fluid pressure being less than a determined threshold, and
is configured to transition the railgear assembly between the road configuration and the rail configuration based on the fluid pressure reaching or exceeding the determined threshold.

2. The system of claim 1, wherein the fluid powered assembly comprises a valve configured to transition between an open position and a closed position, wherein the valve remains in the open position when the pressure is less than the determined threshold, and wherein the valve transitions from the open position to the closed position when the pressure is greater than or equal to the determined threshold.

3. The system of claim 1, wherein the locking assembly comprises a pin lock configured to transition between the first locked position and the unlocked position, wherein the pin lock is configured to prevent the railgear assembly from transitioning between the road configuration and the rail configuration in the first locked position, and wherein the pin lock is configured to allow the railgear assembly to transition between the road configuration and the rail configuration in the unlocked position.

4. The system of claim 3, wherein the locking assembly further comprises a fluid powered cylinder configured to house a portion of the pin lock, wherein the pin lock is configured to transition between a proximal position and a distal position relative to the fluid powered cylinder, and wherein fluid powered cylinder is configured to cause the pin lock to transition from the distal position to the proximal position in response to the pressure provided by the fluid powered assembly.

5. The system of claim 3, wherein the railgear assembly comprises a cam assembly configured to accommodate the pin lock in the first locked position, and wherein the cam assembly does not accommodate the pin lock in the unlocked position.

6. The system of claim 3, wherein the locking assembly further comprises a spring configured to bias the pin lock in the distal position.

7. The system of claim 6, wherein the locking assembly is further configured to transition between the first locked position, the unlocked position, and a second locked position.

8. The system of claim 7, wherein the locking assembly is configured to prevent the railgear assembly from transitioning out of the road configuration in the first locked position, and wherein the locking assembly is further configured to prevent the railgear assembly from transitioning out of the rail configuration in the second locked position.

9. The system of claim 1, the railgear assembly comprising a fluid powered actuator configured to cause the railgear assembly to transition between the road configuration and the rail configuration in response to the pressure provided by the fluid powered assembly.

10. The system of claim 1, wherein the fluid powered assembly further comprises a fluid powered lever, and wherein the user input is mechanically provided via the fluid powered lever.

11. The system of claim 1, wherein the user input is electrically provided via a computing device configured to communicate with the fluid powered assembly.

12. A method, comprising:
providing fluid to a manifold in response to a user input;generating a pressure with the fluid within the manifold;
transitioning, by the pressure, a locking assembly from a first locked position to an unlocked position when the pressure is less than a determined threshold wherein the locking assembly is configured to prevent a railgear assembly from transitioning between a road configuration and a rail configuration in the first locked position, and wherein the locking assembly is configured to allow the railgear assembly to transition between the road configuration and the rail configuration in the unlocked position;
transitioning, by the pressure, the railgear assembly between the road configuration and the rail configuration when the pressure is greater than or equal to the determined threshold;
and transitioning the locking assembly of a railgear from the unlocked position to a second locked position in response to the railgear assembly having transitioned between the road configuration and the rail configuration.

13. The method of claim 12, wherein transitioning the railgear assembly between the road configuration and the rail configuration comprises transitioning a valve of the manifold from an open position when the pressure is less than the determined threshold to a closed position when the pressure is greater than or equal to the determined threshold.

14. The method of claim 12, wherein transitioning the locking assembly from the first locked position to the unlocked position comprises transitioning a pin lock from a distal position relative to a fluid powered cylinder to a proximal position relative to the fluid powered cylinder when the pressure is less than the determined threshold.

15. The method of claim 14, wherein transitioning the pin lock from the distal position to the proximal position comprises removing from the pin lock from a cam assembly of the railgear assembly.

16. A fluid powered assembly, comprising:
a fluid powered actuator configured to transition a railgear assembly between a road configuration and a rail configuration;
a locking assembly configured to transition between a first locked position and an unlocked position, wherein the locking assembly is configured to prevent the railgear assembly from transitioning between the road configuration and the rail configuration in the first locked position, and wherein the locking assembly is configured to allow the railgear assembly to transition between the road configuration and the rail configuration in the unlocked position; and
a manifold configured to receive fluid from a pump in response to a user input, wherein the fluid is configured to generate a pressure within the manifold, wherein the manifold comprises a valve configured to transition from an open position to a closed position when the pressure meets or exceeds a determined threshold, wherein the manifold is configured to provide the fluid to the locking assembly when the valve is in the open position, causing the locking assembly to transition from the first locked position to the unlocked position, and wherein the manifold is configured to provide the fluid to the fluid powered actuator when the valve is in the closed position, causing the fluid powered actuator to transition the railgear assembly between the road configuration and the rail configuration.

17. The fluid powered assembly of claim 16, wherein the locking assembly comprises a pin lock configured to transition between the first locked position and the unlocked position, wherein the pin lock is configured to prevent the railgear assembly from transitioning between the road configuration and the rail configuration in the first locked position, and wherein the pin lock is configured to allow the railgear assembly to transition between the road configuration and the rail configuration in the unlocked position.

18. The fluid powered assembly of claim 17, wherein the locking assembly comprises a fluid powered cylinder configured to house a portion of pin lock, wherein the pin lock is configured to transition between a proximal position and a distal position relative to the fluid powered cylinder, and wherein fluid powered cylinder is configured to cause the pin lock to transition from the distal position to the proximal position in response to the pressure provided by the manifold.

19. The fluid powered assembly of claim 18, wherein the railgear assembly comprises a cam assembly configured to accommodate the pin lock in the first locked position and does not accommodate the pin lock in the unlocked position.

20. The fluid powered assembly of claim 16, further comprising a fluid powered actuator, wherein the valve is configured to provide the fluid to the fluid powered actuator when the pressure is greater than or equal to the determined threshold, causing the railgear assembly to transition between the road configuration and the rail configuration.
